(19) United States
(12) Patent Application Publication
(10) Pub. No.: US 2026/0348702 A1
(43) Pub. Date: Nov. 5, 2026

(54) METHOD FOR CONTROLLING GUIDED MISSILES, AND GUIDED MISSILE, AND AIRCRAFT

(71) Applicant: Airbus Defence and Space GmbH, TAUFKIRCHEN (DE)

(72) Inventor: Max VON SCHLIPPE, TAUFKIRCHEN (DE)

(21) Appl. No.: 19/169,211

(22) Filed: Apr. 3, 2025

(30) Foreign Application Priority Data
Apr. 12, 2024 (DE) 102024110248.9

(51) Int. Cl. F41G 7/30; B64D 1/04

(52) U.S. Cl. CPC F41G 7/30; B64D 1/04

(57) ABSTRACT

A method for controlling at least one guided missile to be launched by an aircraft during flight, a guided missile configured to carry out the method and an aircraft configured to carry out the method are disclosed, wherein the method includes at least one control command transmitted by light signal from the aircraft to the guided missile.

### CROSS-REFERENCES TO RELATED APPLICATIONS

This application claims the benefit of German Patent Application Number 102024110248.9 filed on Apr. 12, 2024, the entire disclosure of which is incorporated herein by way of reference.

### FIELD OF THE INVENTION

The present disclosure relates to a method for controlling at least one guided missile to be launched by an aircraft during flight, to a guided missile, and to an aircraft.

### BACKGROUND OF THE INVENTION

Guided missiles, in particular cruise missiles, can be launched from aircraft in order to then move independently to a target based on their pre-determined mission data and their internal control. Launching is usually carried out from pylons attached externally to corresponding aircraft or platforms. The mission and control data can be transmitted, for example, before or after fastening the guided missile to the respective pylon by a data connection to the guided missile established via a cable.

A mechanical trigger which is installed on the guided missile, such as a contact pin or anchor cable connected to an electrical sensor or switch, can signal to the guided missile's control that it is fastened to the pylon. Alternatively, the guided missile can be accommodated in an aircraft weapon bay. As soon as the guided missile is detached from the pylon or ejected from the weapon bay, the mechanical sensor of the control of the guided missile signals that it now has to undertake its mission, by which it ignites its engine, for example, moves any wings into flight position, etc.

EP 4 060 282 B1, for example, relates to a guided missile having a sleeve-shaped missile body, at least one engine for generating forward thrust, a flight direction control device and an aerodynamic extension. The flight direction control device is rotationally mounted on an upper and/or lower region of the sleeve-shaped missile for the adjustment of a flight direction of the guided missile. The aerodynamic extension has an aerodynamic cross-sectional shape, which is disposed on a left side and/or a right side of the sleeve-shaped missile body.

DE 10 2004 029 487 B4 relates to an aircraft having a fuselage with a launching gear disposed on the underside of the fuselage and, disposed opposite thereto, with a fuselage upper side, wherein-on the fuselage upper side a weapon carrier device is disposed,-the weapon carrier device, when viewed in the cross section of the fuselage at the location of a main launching gear, is disposed above launching gear wells of the main launching gear and above an engine flow duct,-the aircraft has a flight computer installation with a control and mission function as well as an actuating installation for the movement of control surfaces for controlling the aircraft, wherein the control and mission function has a flight guidance function for guiding the aircraft to a target point or launching point and a weapon placement function for launching at least one weapon which can be carried in the weapon carrier device based on a specification,-the aircraft has a respective function assigned to the control and mission function and a flight position sensor technology by way of which the aircraft can be rotated about its longitudinal axis to the degree that a component of the resulting lift force runs from the underside of the fuselage counter to the direction of gravity, and -the flight computer installation is assigned an altitude sensor and the control and mission function has a terrain-tracking flight function based on the altitude data determined by the altitude sensor.

Alternatively, guided missiles can be launched from loading bays of transport aircraft. For this purpose, the guided missiles can be launched, for example during flight, in a metal transport rack using a parachute according to the corresponding standard. Here, too, mission and control data are usually transmitted in advance via a cable to the guided missile. For example, break-off plugs can be used to disconnect the data connection when launching.

In methods and systems for dropping guided missiles known in the prior art, it is disadvantageous that data cables can be damaged and no more data can be transferred to the guided missile after release. Mechanical triggers can be jammed or unintentionally triggered, which also applies to wireless data transmission via radio waves, especially since these can transmit data inadvertently to an undetermined number of guided missiles at the same time. In addition, in the case of methods known in the prior art, the dropping frequency as well as the capacity or number of guided missiles that are able to be launched is restricted by the respective technical conditions.

### SUMMARY OF THE INVENTION

It can be considered an object to provide an improved launching system and method for launching guided missiles, such as cruise missiles, flying drones, or the like, in the air. In particular, it can be considered an object to simplify the handling of guided missiles to be launched in the air and to design them to be safe and reliable at the same time. It can also be considered an object to increase launching capacities.

In particular, this object is achieved by a method for controlling at least one guided missile to be launched by an aircraft during flight, wherein at least one control command is transmitted by light signal from the aircraft to the guided missile.

In the case of a guided missile, the object is achieved, in particular, in that the guided missile is designed to carry out a corresponding method.

In the case of an aircraft, the object is achieved, in particular, in that the aircraft is designed to carry out a corresponding method.

A corresponding launching system can comprise a corresponding guided missile, a corresponding aircraft and/or a corresponding data processing installation. The method can therefore be carried out accordingly by a data processing installation, or with the aid of a computer, which can be implemented as a control apparatus, computer installation and/or server. A computer program can comprise commands which, when the program is executed by a data processing installation or a computer, prompt the latter to carry out the method. A computer-readable storage medium, a computer-readable data carrier and/or a data carrier signal can store or transmit the computer program. A corresponding computer-readable data carrier can be present as a computer-readable medium and/or data carrier signal.

The guided missile can comprise an optical transceiver. The optical transmitter can be disposed on the guided missile in such a manner that it is capable of receiving light signals from the aircraft and/or sending light signals to the aircraft even after the guided missile has been launched. For example, the transceiver can be disposed on an upper side of the guided missile.

A weapon bay and/or a loading bay of the aircraft can be designed for receiving the guided missile and can be equipped with a transceiver for transmitting light signals to the guided missile and/or receiving light signals from the guided missile. Alternatively or in addition, the transceiver can be mounted in an external region of the aircraft in such a manner that light signals can be transmitted to and/or received by the guided missile after launching.

In this way, data can be specifically transmitted wirelessly to a multiplicity of guided missiles, thereby avoiding mechanical errors during launching and increasing launching capacities. Respective transceivers can be actuated in a targeted manner by light signal and/or covered if necessary to avoid reception of the light signal, which can contribute toward improving the technical reliability of the data transmission. In contrast to wireless connections, data transmitted by light signals cannot be intercepted or manipulated outside the transmission range, such as a cargo hold, which increases the information security of the data transmission.

According to one embodiment of the method, it can be provided that the at least one control command is transmitted before and/or after launching. For example, the at least one control command before launching can set the guided missile in a standby mode for the launch or similar. After launching, the at least one control command can inform the guided missile about the launch. This eliminates the need to transmit commands by radio and avoids sources of error associated therewith.

According to one embodiment of the method, it can be provided that the at least one control command comprises an activation instruction for the guided missile. After launching, the at least one control command can activate the guided missile with a view to the latter starting its mission. This allows mechanical triggers to be dispensed with, and the associated sources of error to be avoided.

According to one embodiment of the method, it can be provided that the light signal is transmitted after launching, and that the activation instruction instructs the guided missile to activate its engine unit. Thus, the engine unit can be activated from the aircraft at a predetermined time. This may help, for example, to avoid the use of launching racks and/or parachutes, which could affect the speed and orientation of the guided missile after launching, which would have to be compensated for by the guided missile after its release from the launching rack and/or parachute. The efficiency of the launching procedure can be improved in this way. The capacity and frequency of launching guided missiles from cargo holds of transport aircraft can be increased.

According to one embodiment of the method, it can be provided that the guided missile is substantially inactive before receiving the at least one control command. Thus, the guided missile can be in a kind of sleep mode before receiving the at least one control command. This helps to increase safety during launching.

According to one embodiment of the method, it can be provided that the at least one control command comprises a mission command for a mission of the guided missile and/or is part of a mission data set for the mission. Thus, mission details can be defined and/or communicated before and/or after launching, such as, for example, a launching altitude, launching speed, weather conditions, mission updates, mission assignments, flight path data and/or changes of a planned guided missile flight path or similar. This helps to increase the flexibility of launching procedures and increase the capacity and frequency when launching the missiles from cargo holds of transport aircraft.

According to one embodiment of the method, it can be provided that the at least one control command for the guided missile is transmitted so as to be individually encrypted. Thus, the at least one control command can be specifically transmitted to at least one predetermined guided missile. Both the safety as well as the capacity and frequency of launching guided missiles from cargo holds of transport aircraft can be increased in this way.

According to one embodiment of the method, it can be provided that a multiplicity of guided missiles to be launched, or launched simultaneously and/or successively, each receive at least one control command by light signal. Thus, the guided missiles can be launched successively in a predetermined sequence individually, or simultaneously in small groups or as pairs. This helps to increase the capacity and frequency when launching the missiles from cargo holds of transport aircraft.

Alternatively or additionally, the object is achieved by a method for controlling at least one guided missile to be launched by an aircraft during flight, wherein at least one mission command is transmitted by light signal from the aircraft to the guided missile.

According to one embodiment of the method, it can be provided that the at least one mission command is transmitted before and/or after launching. For example, the at least one mission command before launching the guided missile can serve as a general mission specification by way of which a majority of mission data, a selection of mission data and/or a multiplicity of missions are/is transmitted to the guided missile. After launching, the at least one mission command can complete, complement, correct the mission data, and/or serve to select a mission. Thus, the data transmission can be flexibly designed while dispensing with the transmission of commands via radio, thus avoiding the associated sources of error.

According to one embodiment of the method, it can be provided that the at least one mission command comprises a control command for the guided missile. For example, the at least one mission command can be linked to at least one control command or vice versa. This furthermore helps to design the data transmission to be flexible and to avoid the transmission of commands by radio, thus avoiding the associated sources of error.

According to one embodiment of the method, it can be provided that the light signal is transmitted to a transceiver integrated in the guided missile before and/or after launching. The integrated transceiver can ensure a seamless data connection between the aircraft and the guided missile before and/or after launching, whereby transceivers disposed within or outside the aircraft can establish the data connection on the aircraft side. This additionally helps to design the data transmission to be flexible and secure, while being able to dispense with the transmission of commands via radio.

According to one embodiment of the method, it can be provided that the light signal is transmitted to a transceiver temporarily connected to the guided missile before being launched. The transceiver temporarily connected to the guided missile can be connected to the guided missile by means of a plug connection, for example. This plug connection can be automatically released when the guided missile is launched. Thus, in particular within the aircraft, data can be securely and specifically transmitted to the guided missile and received from the latter.

According to one embodiment of the method, it can be provided that the at least one mission command is part of at least one mission data set for a mission of the guided missile. A multiplicity of mission data sets can be transmitted to the guided missile so as to correspond to a respective multiplicity of missions. In addition, data transmission is designed to be flexible and secure, while the transmission of commands via radio can be dispensed with.

According to one embodiment of the method, it can be provided that the at least one mission command for the guided missile is transmitted so as to be individually encrypted. Thus, the at least one mission command can be specifically transmitted to at least one predetermined guided missile. Both the safety as well as the capacity and frequency of launching guided missiles from cargo holds of transport aircraft can be increased in this way.

According to one embodiment of the method, it can be provided that a multiplicity of guided missiles to be launched, or launched simultaneously and/or successively, each receive at least one mission command by light signal. Thus, the guided missiles can be prepared for launch and/or launched successively in a predetermined sequence individually, or simultaneously in small groups or as pairs. This helps to increase the capacity and frequency when launching the missiles from cargo holds of transport aircraft.

Alternatively or additionally, the object is achieved by a receptacle device for guided missiles for launching from aircraft in the air, wherein the receptacle device comprises a container having a receptacle for at least one guided missile, which container is designed to disintegrate in a predetermined manner due to an air flow prevalent during launching in the air.

In a launching device, the object is achieved, in particular, in that the launching device has a corresponding receptacle device and/or is designed to interact with the receptacle device.

The guided missile received in the container can be released as a result of the disintegration. In other words, the container is separated from the guided missile by its disintegration. The disintegration is preferably passive, i.e., without active intervention on the part of the guided missile and/or the receptacle device or the container. Alternatively or additionally, active disintegration aids can be provided to initiate, promote and/or carry out a disintegration of the container. These disintegration aids can be triggered, for example, by control signals and/or by the air flow and include pressure vessels, explosives or similar, as a result of which an effect that at least partially disintegrates the container can be achieved.

The launching device can provide at least one launching track and/or at least one compartment, preferably a plurality of compartments that are disposed next to one another and/or on top of one another for containers for receiving guided missiles, from where containers can be launched. The launching device can comprise a rack that forms the compartments. The guided missiles and/or their receiving containers can be launched from the rack, for example on respective launching tracks. A launching track can, at least in portions, comprise or include a material with increased sliding capability, or be coated and/or covered with the latter in order to facilitate containers with guided missiles sliding off the launching device.

The solution according to the invention has the advantage that the container including guided missiles is launched during flight and in the course of this releases itself from the guided missile without requiring further aids, such as parachutes or similar. This means that the container can be used for both transporting and launching the guided missile. The receptacle device can comprise the container and/or be designed as such. This means that the container per se can form the receptacle device. This helps to improve the launching of guided missiles, such as cruise missiles, flying drones, or similar, in the air. In particular, the handling of guided missiles to be launched during flight can be simplified and at the same time designed to be safe and reliable.

According to one embodiment of the receptacle device, it can be provided that an internal contour of the receptacle corresponds at least in portions to an external contour of the at least one guided missile. The receptacle can be designed as a negative shape of a casing of the guided missile, or be complementary to the guided missile, respectively. The receptacle can be formed in a receptacle part and/or in a cover part of the container. In this way, the guided missile can be received in the container so as to be encased ideally in a form-fitting manner. This facilitates a transport protection of the guided missile, which helps to furthermore simplify its handling.

According to one embodiment of the receptacle device, it can be provided that an attack zone is formed on the container, which points in a flight direction of the aircraft and/or of the guided missile and is designed to facilitate disintegration of the container by an air flow prevalent during launching. The attack zone can be disposed on the container in such a way that the container advantageously rips open and releases the guided missile ideally without residue. In this way, launching can be simplified and launching capacities and frequencies increased.

According to one embodiment of the receptacle device, it can be provided that the attack zone tapers from a front of the container in the direction of the receptacle. The attack zone can thus be designed to concentrate an air flow prevalent during launching in a suitable manner in order to generate a back pressure which initiates or facilitates disintegration of the container. Thus, ripping of the container and an ideally residue-free release of the at least one guided missile can be furthermore facilitated.

According to one embodiment of the receptacle device, it can be provided that the attack zone is at least in portions designed to be wedge-shaped, pyramid-shaped, conical and/or frustoconical. Design embodiments of this type of the attack zone can be selected according to the respective requirements so as to generate and direct a back pressure as desired, which initiates or facilitates disintegration of the container. In this way, ripping of the container and an ideally residue-free release of the at least one guided missile can be furthermore facilitated.

According to one embodiment of the receptacle device, it can be provided that a center line of the attack zone is disposed so as to extend substantially parallel to and/or on a central axis of the container. The attack zone can be designed to be symmetrical in relation to the central axis of the container. In this way, an ideally uniform and balanced disintegration of the container and its release from the guided missile can be facilitated, ideally without negatively impacting its flight path after launching.

According to one embodiment of the receptacle device, it can be provided that at least one disintegration-facilitating predetermined breaking point and/or a passage for leading through a transmission means, cable and/or light signal from outside the container is integrally molded on the container in its receptacle. Furthermore, at least one cut-out in the form of a clearance and/or a recess can be formed on the container in order to be able to attach aids thereto, such as lifting and/or lashing means, for transporting the container including guided missiles received therein. Predetermined breaking point, passage and/or cut-out can improve the handling of the guided missile and help facilitate the desired disintegration of its container.

According to one embodiment of the receptacle device, it can be provided that the container is at least partially made of a lightweight material that self-disintegrates due to the air flow. For example, paper, cardboard, paper mâché, fibrous materials, foam materials and/or other lightweight materials can be formed as lightweight materials, ideally without the use of heavy or rigid and/or hard materials, such as metal parts. The material of the container can at least in portions be formed with honeycombs, pore structures, rib structures, wave structures and/or honeycomb structures while forming cavities. On the one hand, this thus facilitates the handling of the container per se. On the other hand, it prevents the container from causing damage after it has been launched and has disintegrated upon hitting the ground. Moreover, the disintegration per se is facilitated.

### BRIEF DESCRIPTION OF THE DRAWINGS

A more specific description of some details is given below with reference to the accompanying drawings. The illustrations are schematic and not true to scale. Identical reference signs refer to identical or equivalent elements. In the figures:

FIG. 1 shows a schematic perspective view of an air launching system with an aircraft and guided missiles that are able to be launched from the latter.

FIG. 2 shows a schematic sectional view of a container for guided missiles along a section line A-A illustrated in FIG. 4.

FIG. 3 shows a schematic sectional view of the container for guided missiles along a section line B-B illustrated in FIG. 5.

FIG. 4 shows a schematic lateral view of the container for guided missiles.

FIG. 5 shows a schematic rear view of a container for guided missiles.

FIG. 6 shows a schematic rear view of the air launching system with the aircraft prepared for the launching of the guided missiles.

FIG. 7 shows a schematic perspective view of the air launching system with guided missiles launched from the aircraft.

### DETAILED DESCRIPTION OF THE PREFERRED EMBODIMENTS

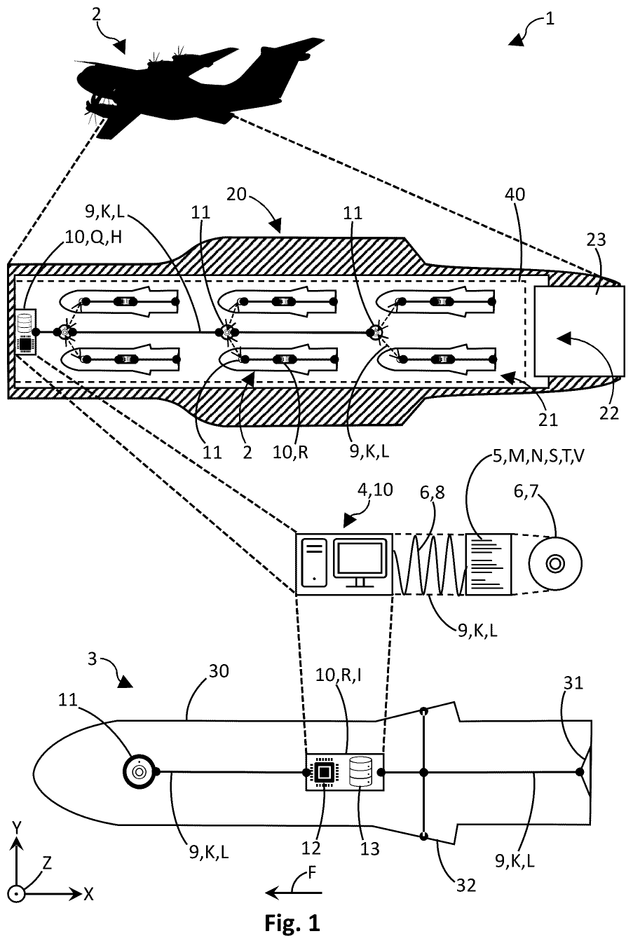

FIG. 1 shows a schematic perspective view of an air launching system 1 with an aircraft 2 and guided missiles 3 which are able to be launched from the latter, which extends in a longitudinal direction X, a transverse direction Y and a height direction Z, which conjointly define a Cartesian coordinate system. For controlling the air launching system 1, at least one data processing installation 4 is provided, with the aid of which control data sets S with control commands T and/or mission data sets M with mission commands N in the form of computer-readable instructions can be processed. The aircraft 2 and/or the guided missile 3 can carry out an air launching method and missions with the aid of a computer program 5, based on corresponding computer-readable instructions contained therein.

The computer program 5 can be stored at least in portions on a computer-readable data carrier 6 and define a control data set S with control commands T, a mission data set M with mission commands N and other data sets, parameters, markings, keys and/or process steps described herein, and manage their generation, use and/or handling. The computer-readable data carrier 6 can be present as a computer-readable medium 7 and/or data carrier signal 8. In particular, the data carrier signal 8 can be designed to be bi-directionally transmittable via light signals, cable connections and other wired and/or non-wired transmission means 9 and communication networks between the aircraft 2 and the guided missile 3.

Control apparatuses 10 of the air launching system 1 can be designed as data processing installations 4 and/or comprise these as well as optical transceivers 11, or be connected thereto in a data-transmitting manner at least by respective data transmission means 9. The control apparatuses 10 can furthermore comprise a control unit 12 and a data storage unit 13. With the aid of the control unit 12, functions and components of the aircraft 2 and/or the guided missile 3 can be controlled, in particular on the basis of corresponding mission data sets M, mission commands N, control data sets R and/or control commands R, which can be stored in the data storage unit 13. Accordingly, the respective control unit 12 in the aircraft 2 and/or guided missiles 3 can function as a data source Q or transmitter and/or as a data sink R or receiver.

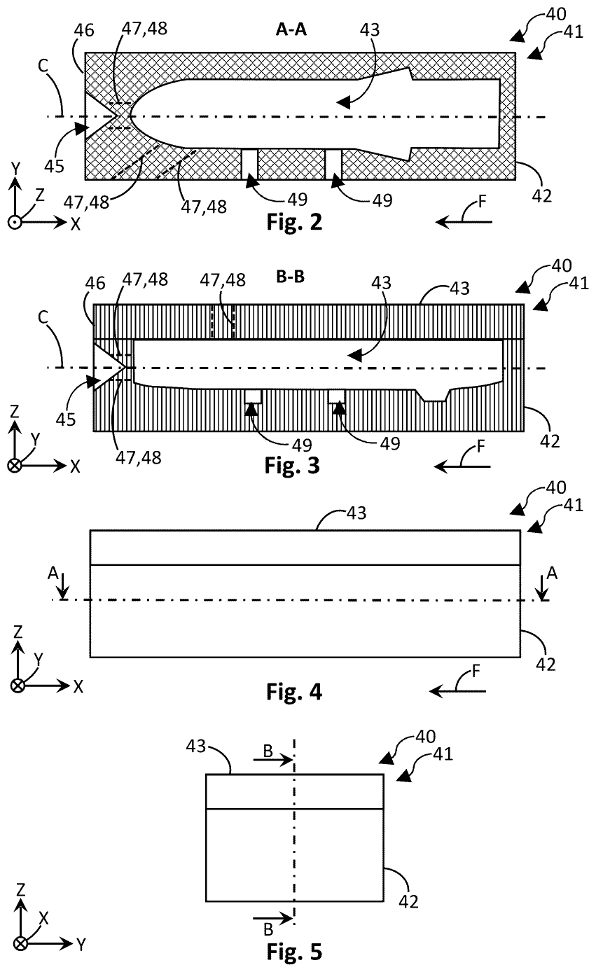

The aircraft 2 has, for example, a fuselage 20 with a cargo bay, designed as a cargo hold 21, for guided missiles 3. Shown in FIG. 2 is part of the fuselage 20 including the cargo hold 21 in a schematic sectional view along a plane that extends parallel to the longitudinal direction X and the height direction Y and extends above the guided missile 3 disposed in the cargo hold 21. The cargo hold 21 has an opening 22 facing opposite a flight direction F of the aircraft 2 and/or the guided missile 3, which is designed to be closable with a hatch 23. In the present example, a plurality of guided missiles 3 are disposed in the cargo hold 21, namely two rows of three guided missiles 3 mutually spaced apart in the transverse direction Y.

In the cargo hold 21, the aircraft-provided transceivers 11 can be disposed in such a way that they can exchange data with the guided missiles 3 by a light signal L, in particular corresponding mission data sets M, mission commands N, control data sets R and/or control commands R. In the present example, the transceivers 11 are set out between the two rows of the guided missiles 3. One transceiver 11 assigned to the aircraft 2 is, in each case, two transceivers 11 of, in each case, one guided missile 3. Thus, an aircraft-side control apparatus 10 designed as a main computer H (master) can communicate with at least one guided missile-side control apparatus 10 designed as a satellite computer I (slave), for example with a multiplicity of guided missile-side control apparatuses 10 simultaneously. The communication can be provided with an individual encryption V or a corresponding key for a respective guided missile 3, and thus be secure.

For example, the transceivers 11 of the aircraft 2 are set out in a chain along the guided missiles 3 or between the rows of the guided missiles 3. The individual transceivers 11 of the aircraft 2 can be connected to one another and to the control apparatus 10 with the aid of the transmission means 9 in the form of cables K, which serve on the aircraft side at least predominantly as a data source Q for the control apparatuses 10 of the guided missiles 3, which are at least temporarily predominantly designed as a data sink R. The transceivers 11 can be provided both on the aircraft and on the guided missile with data interfaces and/or buses corresponding to the respective requirements by way of plug connections, for example, USB or similar. Thus, the transceiver 11 can be releasably attached to the aircraft 2 or its control apparatus 10 and/or to the guided missile 3 or its control apparatus 10, respectively.

The guided missile 3 has an outer casing 30 which can receive its control apparatus 10. The guided missile 3 can have a drive unit 31, for example a jet and/or rocket engine, and have flight aids 32, for example in the form of wings and/or fins, which can be controlled or feedback-controlled with the aid of the control apparatus 10 by means of corresponding drives and/or actuators (not shown). In the present example, the guided missile is received in a receptacle device 40 in such a way that it can be launched during flight, counter to the flight direction F, via the hatch 23 out of the opening 22 from the cargo hold 21.

FIG. 2 shows a schematic sectional view of a container 41 for guided missiles 3 as a possible part of the receptacle device 40, along a section line A-A illustrated in FIG. 4. The container 41 has a receptacle part 42 with a tub-like receptacle 43 formed therein, which by way of a lid-like cover part 44 (see FIGS. 3 to 5) can be designed to be closable. The receptacle 43 can be designed substantially as a negative shape of the casing 30 of the guided missile 3. Thus, the guided missile 3 can be embedded in the container 41 in an almost completely form-fitting manner.

The container 41 can substantially comprise materials and/or consist of a material which are or is, on the one hand, able to encase the guided missile 3 so as to be protected against external influences and to protect it, in particular, from transport damage. On the other hand, corresponding materials can be selected in such a way that the container 41 enables it to be launched from the aircraft 2 with guided missiles 3 received therein. Thus, materials, construction and/or structure of the container 41 can enable its independent release from the guided missile 3 ideally shortly after launching.

For example, the container 41 can be made of paper, cardboard, paper mâchê, fibrous materials, foam materials and/or other lightweight materials, ideally without the use of heavy or rigid and/or hard materials, such as metal parts. Upon being launched from the aircraft 2, lightweight materials have the advantage that they do not cause any or at most hardly any damage when they hit the ground. In particular, the materials can disintegrate during launching. In other words, the container 41 can be designed so that it is disintegrated by air flows when launching. In order to facilitate its disintegration, the material of the container 41 can at least in portions be formed with honeycombs, pore structures, rib structures, wave structures and/or honeycomb structures while forming cavities.

Attack zones 45 can be formed on the container 41, which, for example, point in the flight direction F and facilitate disintegration of the container 41 by suitably directing air flows impinging the container 41 opposite to the flight direction F. Thus, for example, an attack zone 45 can be formed on a front side 46 of the container 41 facing in the flight direction F. For example, the attack zone 45 can be of a conical design, wherein a base of the conical shape points in the flight direction F and its tip in the direction of the receptacle 43. A central axis of the conical shape can extend on a central axis C of the container 41.

For example, the attack zone 45 can be designed in such a way that it concentrates a back pressure generated by the air flow in the structure of the container 41 during launching in such a way that the latter disintegrates as quickly and favorably as possible and is released from the guided missile 3 as a result. In any case, it can be advantageous when the attack zone 45 tapers in the direction of the receptacle 43, counter to the flight direction F. For this purpose, the attack zone 45 can be designed to be wedge-shaped, conical, frustoconical and/or pyramid-shaped.

Furthermore, predetermined breaking points 47, passages 48, and/or clearances 49 can be disposed or integrally molded on the container 41. Predetermined breaking points 47 and/or passages 48 can be disposed in combination as cuts, slots, planes and/or weak points in such a manner that, on the one hand, they facilitate disintegration of the container 41 during launching and, on the other hand, enable transmission means 9, cables K and/or light signals L to be fed through a wall from outside the container 41 into the receptacle 43, or out of the latter, respectively. Thus, the predetermined breaking points 47 and/or passages 48 can be disposed so as to correspond to the attack zone 45 in such a way that they facilitate disintegration of the container, and/or facilitate access to the guided missile 3 received in the receptacle 43 for control apparatuses 10 and/or transceivers 11 to be disposed outside and/or within the container 41.

For example, the predetermined breaking points 47 and/or passages 48 can extend parallel and/or obliquely to the central axis C and/or flight direction F and/or form a connection or a passage between the attack zone 45 and the receptacle 43. Thus, a symmetrical arrangement of the predetermined breaking points 47 and/or passages 48 can be helpful in distributing forces acting on the container 41, in particular during launching, as evenly or symmetrically as possible, for example, in terms of the central axis C, so that an orderly release of the container 41 from the guided missile 3 takes place. Thus, the container 41 can literally rip open, in particular in the region of the predetermined breaking points 47 and/or passages 48, and release the guided missile 3. The clearances 49 can also be disposed symmetrically on the container 41 and serve to insert loading aids (not shown), such as hooks, lifting means, lashing means, fork arms of forklift trucks, or similar, into the container 41, attach them to the guided missile 3 and/or support them on or below the latter.

FIG. 3 shows a schematic sectional view of the container 41 for guided missiles 3, along a section line B-B illustrated in FIG. 5. It becomes obvious here that any predetermined breaking points 47 and/or passages 48 can also be attached and/or integrally molded in the cover part 44 now attached to the receptacle part 42. For example, the cut-outs 49 are attached in such a way that fork arms of a forklift truck (not shown) can be guided below the guided missile 3. Alternatively or additionally, a profile of a separation line between the receptacle part 42 and the cover part 44 can, for example, extend on the central axis C. In order to achieve access to the guided missile 3 disposed in the receptacle 43, the cover part 44 can be removed in whole or in part, for example, in that clearances, plugs, stoppers and/or closures (not shown) are provided in the region of predetermined breaking points 47, passages 48 and/or cut-outs 49 in such a way that they allow direct access to the receptacle, or partial removal or opening of the container 41.

FIG. 4 shows a schematic lateral view of the container 41 for guided missiles 3. FIG. 5 shows a schematic rear view of a container 41 for guided missiles 3. It becomes obvious here that the container 41 can be designed to be substantially cuboid. This can help to simplify the production, handling, stowage and/or launching of the container 41. Furthermore, the container can be sealed, coated, packaged or otherwise treated in a desired manner inside or outside to meet the respective requirements.

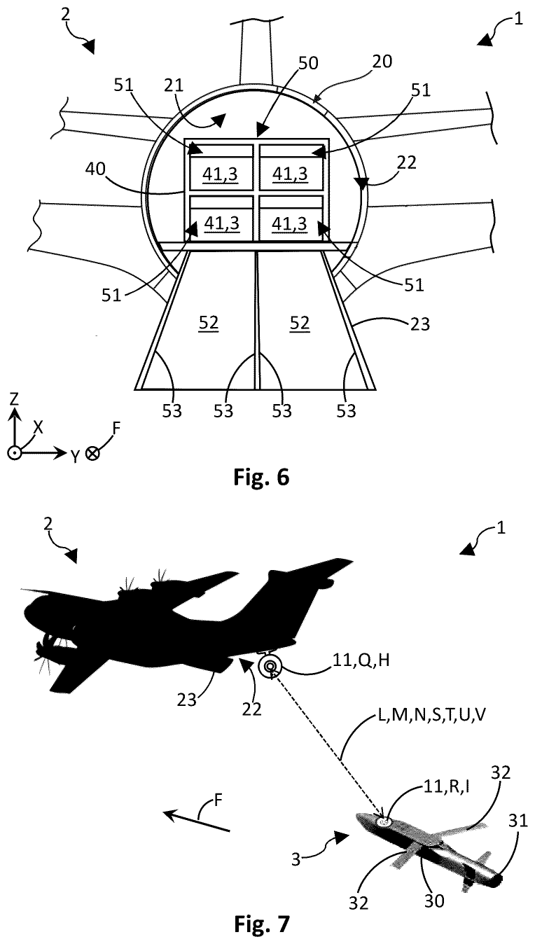

FIG. 6 shows a schematic rear view of the air launching system 1 with the aircraft 2 prepared for the launching of the guided missiles 3. Thus, the hatch 23 to the cargo hold 21 or any other carrier or receptacle space for guided missiles 3 can be opened during flight. The guided missiles 3, or containers 41 of the receptacle device 40 receiving the guided missiles 3, are visible through the opening 22. The receptacle device 40 can conjointly form a launching device 50 or transition into the latter. For example, a combined receptacle and/or launching device 40, 50 can thus be provided.

The receptacle and/or launching device 40, 50 can form at least one compartment 51 for guided missiles 3 or for containers 41 receiving the latter. For example, a multiplicity of compartments 51, which can be disposed next to one another, on top and/or below one another, can be provided. In this way, a multiplicity of guided missiles 3, or containers 41 receiving the latter, can be launched simultaneously or in a predetermined sequence. The launching device can have launching tracks 52, via which the guided missiles 3 and/or containers 41 receiving the latter can slide out counter to the flight direction F from the receptacle and/or launching device 40, 50.

For example, the launching tracks 52 can be disposed on the hatch 23 and/or integrated in the latter. Guide elements 53 can be provided, which delimit a launching track for the guided missiles 3 and/or containers 41 receiving the latter, at least in portions. For example, the guide elements 53 can be designed as guide rails which laterally delimit the launching tracks so as to support, or guide, the guided missiles 3 and/or containers 41 receiving the latter, in particular in and counter to the transverse direction Y, during launching. The launching track can be provided or coated with a material that facilitates sliding, for example certain plastics materials such as Teflon, or similar.

FIG. 7 shows a schematic perspective view of the air launching system 1 with a guided missile 3 launched from the aircraft 2. During launching, the guided missile 3 can initially still be in a resting state. After launching, the container 41 can release itself from the latter and/or the guided missile 3 can receive a control command T, for example in the form of an activation instruction U, preferably by light signal L, which can be sent for example by a transceiver 11, attached to the inside and/or the outside of the aircraft 2, to the guided missile 3 so that the latter receives the signal with the aid of its transceiver 11. The guided missile 3 can be activated by the activation instruction U and be prompted to start its mission, for example. As a result of the activation, the guided missile can activate its drive unit 31, for example by igniting its engine. Moreover, flight aids 32 can be moved to a flight position or intervene in the flight path of the guided missile 3 by being deployed, or being moved in any other way that influences the flight path of the guided missile 3.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

### LIST OF REFERENCE SIGNS

1 Air launching system
2 Vehicle/aircraft
3 Guided missile
4 Data processing installation
5 Computer program
6 Computer-readable data carrier
7 Computer-readable medium
8 Data carrier signal
9 Transmission means
10 Control apparatus
11 Transceiver (optical)
12 Control unit
13 Data storage unit
20 Fuselage
21 Cargo hold
22 Opening
23 Hatch
30 Casing
31 Drive unit
32 Flight aid
40 Receptacle device
41 Container
42 Receptacle part
43 Receptacle
44 Cover part
45 Attack zone
46 Front side
47 Predetermined breaking point
48 Passage
49 Cut-out/clearance
50 Launching device
51 Compartment
52 Launching track
53 Guide element
C Centre/central axis
F Flight direction
H Main computer/master
I Satellite computer/slave
K Cable
L Light signal
M Mission data set
N Mission command
Q Data source/transmitter
R Data sink/receiver
S Control data set
T Control command
U Activation instruction
X Longitudinal direction
Y Transverse direction
Z Vertical direction

1. A method for controlling at least one guided missile to be launched by an aircraft during flight, wherein at least one control command is transmitted by light signal from the aircraft to the at least one guided missile.

2. The method according to claim 1, wherein the at least one control command is transmitted before, after, or both before and after launching.

3. The method according to claim 1, wherein the at least one control command comprises an activation instruction for the at least one guided missile.

4. The method according to claim 3,
wherein the light signal is transmitted after launching, and
wherein the activation instruction instructs the at least one guided missile to activate its drive unit.

5. The method according to claim 1, wherein the at least one guided missile is substantially inactive before receiving the at least one control command.

6. The method according to claim 1, wherein the at least one control command comprises a mission command for a mission of the at least one guided missile, is part of a mission data set for the mission, or both comprises a mission command for a mission of the at least one guided missile and is part of a mission data set for the mission.

7. The method according to claim 1, wherein the at least one control command for the at least one guided missile is transmitted so as to be individually encrypted.

8. The method according to claim 1, wherein a multiplicity of guided missiles to be launched, or launched simultaneously or successively, each receive at least one control command by light signal.

9. A guided missile, wherein said guided missile is configured to carry out a method according to claim 1.

10. An aircraft, wherein said aircraft is configured to carry out a method according to claim 1.
